(19) United States
(12) Patent Application Publication
(10) Pub. No.: US 2015/0127577 A1
(43) Pub. Date: May 7, 2015

(54) METHOD AND APPARATUS FOR RATING OBJECTS

(71) Applicant: B-SM@RK LIMITED, Dublin (IE)

(72) Inventors: Nicola Farronato, Dublin (IE); Paolo Maria Panizza, Bassano del Grappa (IT)

(73) Assignee: B-SM@RK LIMITED, Dublin (IE)

(21) Appl. No.: 14/398,654

(22) PCT Filed: May 3, 2013
(86) PCT No.: PCT/EP2013/059243

§ 371 Date: Nov. 3, 2014

Related U.S. Application Data
(60) Provisional application No. 61/642,597, filed on May 4, 2012.

(51) Int. Cl. G06Q 30/02

(52) U.S. Cl. CPC G06Q 30/0282
USPC 705/347

(57) ABSTRACT

A method and apparatus can be configured to provide profile information of a current user. The method can also receive a rating of an object. The received rating of the object is based on a plurality of other ratings of the object inputted by a plurality of other users. The plurality of other ratings are transformed to a plurality of weighted ratings, the plurality of weighted ratings are transformed to determine the received rating of the object. The received rating of the object is determined according to the provided profile information of the current user.

### BACKGROUND

1. Field

Embodiments of the invention relate to a method and apparatus for inputting and providing ratings for objects.

2. Description of the Related Art

Emotions can be generally understood as subjective experiences that may be associated with certain psychophysiological expressions. Emotional expressions are generally understood as observable behaviours that reveal an internal affective state. Although a person can readily express emotions to others who are engaged in face-to-face conversation with the person, it may be more difficult for the person to express emotions to others through written text alone. “Emoticons” can be used as pictorial representations of emotions. Emoticons are generally understood as a combination of different punctuation marks that represents facial expressions associated with emotions. Emoticons are sometimes electronically posted by a user at a user terminal to a website server or directly to another terminal of a recipient user. Users may then view the posted emoticons using an electronic interface, such as a graphical user interface displayed by an electronic device.

### SUMMARY

According to a first embodiment, a method may comprise providing profile information of a current user. The method may also include receiving a rating of an object. The received rating of the object is based on a plurality of other ratings of the object inputted by a plurality of other users. The plurality of other ratings are transformed to a plurality of weighted ratings. The plurality of weighted ratings are transformed to determine the received rating of the object. The received rating of the object is determined according to the provided profile information of the current user.

In the method of the first embodiment, the received rating of the object can be a multi-dimensional rating. Each of the other ratings inputted by the plurality of other users is a multi-dimensional rating.

In the method of the first embodiment, transforming the plurality of other ratings to the plurality of weighted ratings can comprise applying a subjectivity weighting function that depends on individual characteristics of the other users, personality traits of the other users, demographic data of the other users, and a first ontology dependent on the object.

In the method of the first embodiment, transforming the plurality of weighted ratings to determine the received rating of the object comprises applying a reverse-weighting function that depends on individual characteristics of the current user, personality traits of the current user, demographic data of the current user, and a second ontology dependent on the object.

In the method of the first embodiment, the dimensions of the multi-dimensional rating are affective expressions defined by a theory and model of emotions.

In the method of the first embodiment, transforming the plurality of other ratings to the plurality of weighted ratings comprises applying a subjectivity weighting function that depends on a first ontology dependent on the object, a second ontology that is a semantics/psycholinguistic ontology, and a third ontology that is a psychological behavioral ontology.

In the method of the first embodiment, the method can further comprise processing the weighted ratings using an aggregator engine & reasoner. Processing the weighted ratings using the aggregator engine & reasoner can depend on a fourth ontology that is an emotions/behavior ontology.

According to a second embodiment, an apparatus can comprise at least one processor. The apparatus can also comprise at least one memory including computer program code. The at least one memory and the computer program code can be configured, with the at least one processor, to cause the apparatus at least to provide profile information of a current user. The apparatus can also receive a rating of an object. The received rating of the object is based on a plurality of other ratings of the object inputted by a plurality of other users. The plurality of other ratings are transformed to a plurality of weighted ratings, the plurality of weighted ratings are transformed to determine the received rating of the object, and the received rating of the object is determined according to the provided profile information of the current user.

In the apparatus of the second embodiment, the received rating of the object is a multi-dimensional rating, and each of the other ratings inputted by the plurality of other users is a multi-dimensional rating.

In the apparatus of the second embodiment, transforming the plurality of other ratings to the plurality of weighted ratings can comprise applying a subjectivity weighting function that depends on individual characteristics of the other users, personality traits of the other users, demographic data of the other users, and a first ontology dependent on the object.

In the apparatus of the second embodiment, transforming the plurality of weighted ratings to determine the received rating of the object comprises applying a reverse-weighting function that depends on individual characteristics of the current user, personality traits of the current user, demographic data of the current user, and a second ontology dependent on the object.

In the apparatus of the second embodiment, the dimensions of the multi-dimensional rating are affective expressions defined by a theory and model of emotions.

In the apparatus of the second embodiment, transforming the plurality of other ratings to the plurality of weighted ratings can comprise applying a subjectivity weighting function that depends on a first ontology dependent on the object, a second ontology that is a semantics/psycholinguistic ontology, and a third ontology that is a psychological behavioral ontology.

In the apparatus of the second embodiment, the apparatus can be further caused to process the weighted ratings using an aggregator engine & reasoner. Processing the weighted ratings using the aggregator engine & reasoner can depend on a fourth ontology that is an emotions/behavior ontology.

According to a third embodiment, a computer program product can be embodied on a non-transitory computer readable medium. The computer program product can be configured to control a processor to perform a process. The process can comprise providing profile information of a current user. The process can also include receiving a rating of an object. The received rating of the object is based on a plurality of other ratings of the object inputted by a plurality of other users, the plurality of other ratings are transformed to a plurality of weighted ratings, the plurality of weighted ratings are transformed to determine the received rating of the object, and the received rating of the object is determined according to the provided profile information of the current user.

In the computer program product of the third embodiment, the received rating of the object is a multi-dimensional rating, and each of the other ratings inputted by the plurality of other users is a multi-dimensional rating.

In the computer program product of the third embodiment, transforming the plurality of other ratings to the plurality of weighted ratings can comprise applying a subjectivity weighting function that depends on individual characteristics of the other users, personality traits of the other users, demographic data of the other users, and a first ontology dependent on the object.

In the computer program product of the third embodiment, transforming the plurality of weighted ratings to determine the received rating of the object can comprise applying a reverse-weighting function that depends on individual characteristics of the current user, personality traits of the current user, demographic data of the current user, and a second ontology dependent on the object.

In the computer program product of the third embodiment, the dimensions of the multi-dimensional rating can be affective expressions defined by a theory and model of emotions.

In the computer program product of the third embodiment, transforming the plurality of other ratings to the plurality of weighted ratings can comprise applying a subjectivity weighting function that depends on a first ontology dependent on the object, a second ontology that is a semantics/psycholinguistic ontology, and a third ontology that is a psychological behavioral ontology.

In the computer program product of the third embodiment, the process can further comprise processing the weighted ratings using an aggregator engine & reasoner. Processing the weighted ratings using the aggregator engine & reasoner can depend on a fourth ontology that is an emotions/behavior ontology.

### BRIEF DESCRIPTION OF THE DRAWINGS

For proper understanding of the invention, reference should be made to the accompanying drawings, wherein:

FIG. 1 illustrates two different types of rating systems.

FIG. 2 illustrates different emotional models, and relations between them and personality, that can be used to express a multidimensional rating in accordance with one embodiment.

FIG. 3 illustrates transforming a rating to a weighted rating to an adjusted rating in accordance with one embodiment.

FIG. 4 illustrates example rating systems in accordance with one embodiment.

FIG. 5 illustrates an affective rating system in accordance with another embodiment.

FIG. 6 illustrates comparing a simple rating system with a personalized rating system in accordance with one embodiment.

FIG. 7 illustrates comparing a simple rating system with a personalized rating system in accordance with one embodiment.

FIG. 8 illustrates comparing a simple rating system with a personalized rating system in accordance with one embodiment.

FIG. 9 illustrates graphical user interfaces of an input device in accordance with one embodiment.

FIG. 10 illustrates a graphical user interface of an input device in accordance with another embodiment.

FIG. 11 illustrates a graphical user interface of an input device in accordance with another embodiment.

FIG. 12 illustrates a graphical user interface of an input device in accordance with another embodiment.

FIG. 13 illustrates graphical user interfaces of an input device in accordance with another embodiment.

FIG. 14 illustrates a flowchart of a method in accordance with one embodiment.

FIG. 15 illustrates an apparatus in accordance with one embodiment.

FIG. 16 illustrates an apparatus in accordance with one embodiment.

FIG. 17 illustrates an apparatus in accordance with one embodiment.

### DETAILED DESCRIPTION

One embodiment of the present invention is directed to a rating system. The rating system can serve as a real-time feedback system. The rating system can also serve as a recommendation system. The rating system can be an online rating system. The embodiment can be either a standalone system or a plug-in component of a host system.

One embodiment of the present invention can be considered to be an open-listening platform. This embodiment can be considered to be “open” because the embodiment can be used as a 3rd-party service. The embodiment can also be considered to be “listening” because a function of the embodiment can be to receive user input in the form of feedback/rating information. The feedback/rating information can correspond to an affective expression.

One embodiment can provide an “explicit affective feedback” system. With such an explicit feedback system, a user can explicitly select feedback/rating information that corresponds to an appropriate affective expression. The affective expression can include a fixed lexicon. The fixed lexicon of each affective expression can depend on the specific emotional model that is used, as described in more detail below.

One embodiment allows a user to submit a general multi-dimensional rating for an object (Obj) from a user terminal to a server or to a receiving terminal. The user can submit the rating by interacting with an electronic interface (displayed by the user terminal) to transmit data/communication that represents the rating for the object. A component of the electronic interface can be generally referred to as a “widget.” As described in more detail below, an interface component can be displayed by a graphical user interface (GUI) that presents a graphical representation of an emotional model to the user. The GUI can be presented on an electronic device used by the user. Examples of different electronic devices which can display a GUI include smartphones, tablets, computers, and other types of computing hardware, for example.

One embodiment is directed to taking into account a user's subjective features when presenting a rating/ranking that is based upon inputted ratings from other users. These other users can first input ratings via their own input devices.

As described above, one embodiment allows users to rate/rank an object that is to be evaluated. The object can correspond to a travel experience, a restaurant experience, an entertainment experience, or anything else that can be rated. Each past user (Ux) of a plurality of past users can evaluate/rate the object. Next, a current user (Uo), who is interested in Obj, can then examine the ratings of the object provided by the population of past users.

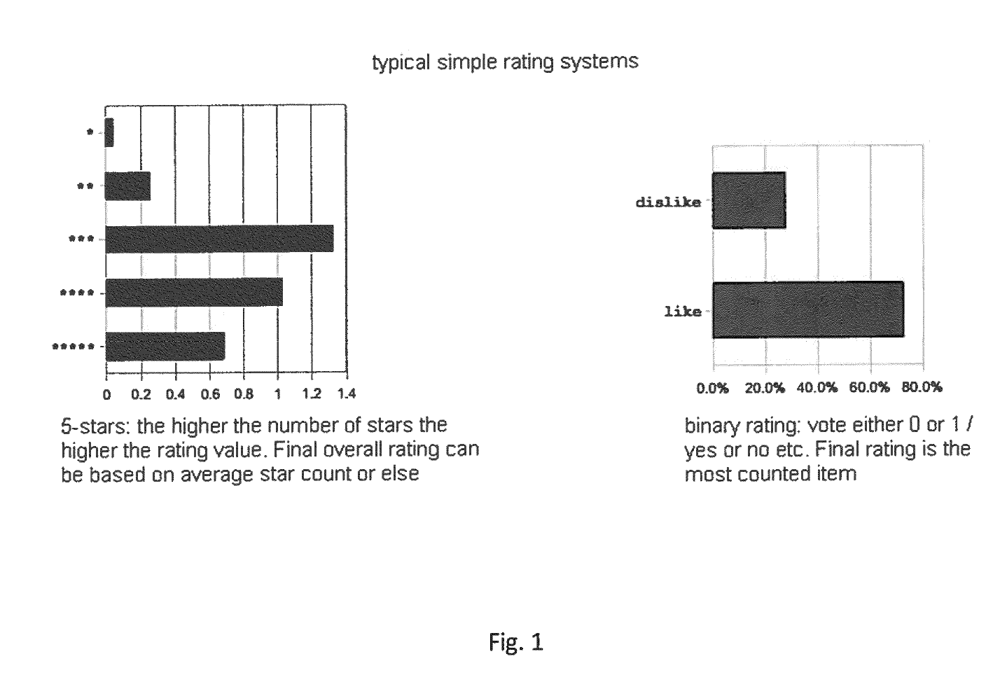

FIG. 1 illustrates two different types of rating systems. FIG. 1 shows an example first system that corresponds to a five-star system. Each user (Ux) can use the five-star system to rate an object by assigning a number of stars to the object. FIG. 1 also shows an example second system that uses a binary system. Users can use the binary system to rate the object by assigning a “like” or a “dislike” to the object. Although two different types of rating systems are shown in FIG. 1, other types of rating systems can be used in conjunction with embodiments of the present invention.

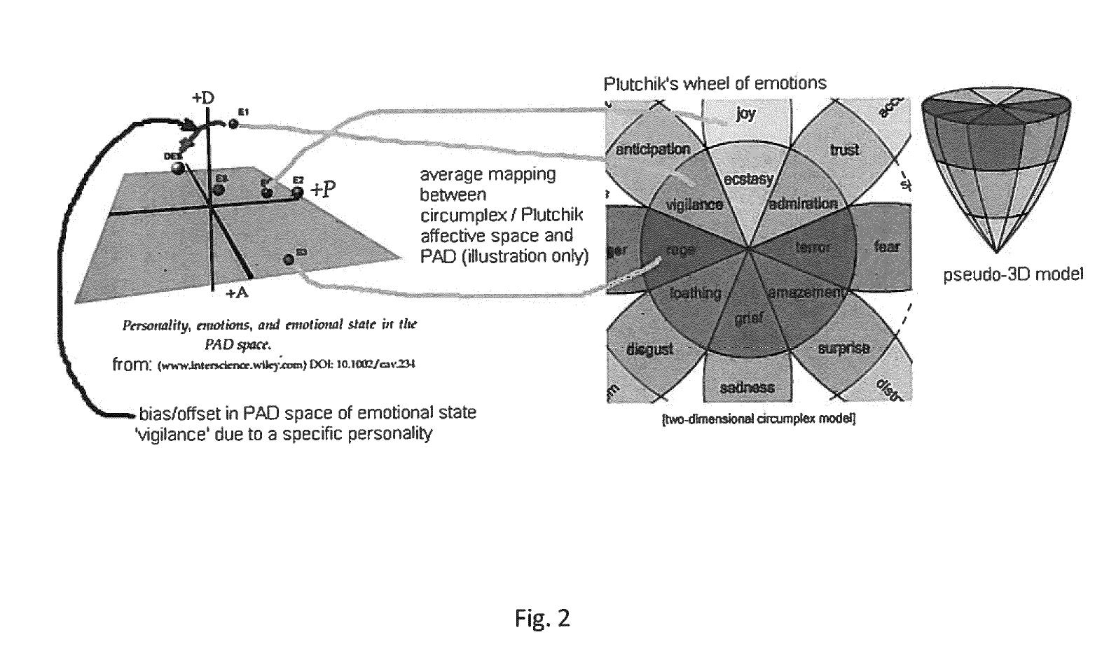

FIG. 2 illustrates different emotional models that can be used to express a multidimensional rating in accordance with one embodiment. One emotional model can be what is known as Russell-Mehrabian's 3D model of emotions, personality, and temperament (PAD). Another emotional model can be what is known as Plutchik's theory and model of emotions (PKM). As shown in FIG. 2, data expressed using PAD can be mapped onto PKM.

A variety of users can use the method and apparatus of the present invention to rate/evaluate objects. Each past user (Ux) in a population of past users can provide a rating Ri of an object. Ri can be a multi-dimensional rating. The information for each of the different dimensions of a rating can be ascertained from a profile of the user providing the rating. The dimensions of the vector Ri can be at least: the affective word/expression selected from the lexicon (which translates to its own semantic-affective space according to the affective model in use, and associated emoticon), the (optional) free comment text (which can be considered a generic semantic dimension) along with the (optional) “motto” (aka a canned phrase/response, which is a generic pointer/URL to either internal or external libraries), the (optional, and if allowed) geo-location data, the values of the N parameters for the (optional) non-affective, usually Object-specific part of the user expression. The profile for the user can be completed by the user upon registration by the user with a membership server that stores information about each user, for example. The membership server can be a computer system that governs those who can and cannot input ratings. Each rating Ri can be first transformed into a weighted rating WRi, as described below. WRi can reflect a subjective semantic-affective value conveyed by a selected lexical term. The dimensions of the semantic-affective space in which such value can be expressed depend upon the specific emotional model used to express the multidimensional rating. Moreover, such space can be subdivided in classes or categories of emotions, so that each class can be used as an equivalent of all affective terms/states assigned to it, thereby reducing the minimum dictionary needed for a coarse complete description of the space. For example, if PAD is used as the specific emotional model, the possible affective dimensions are 3, along with the semantic dimension of the lexical terms and 8 macro-categories; PKM defines 32 classes while the affect space is pseudo-3D; SenticNet defines 4 affective dimensions and 24 macro-classes; if SentiWordNet is used, the duo-polar positive/negative, objective/subjective dimensions are available with 9 classes. The choice of the semantic-affective model/space to use depends on tradeoffs on available resources and the application case, though the system must ensure data and metric consistency across usage domains if multi-model cross-operation is allowed.

Ri=>f(Ii,Pi,Di,On(Obj))=>WRi

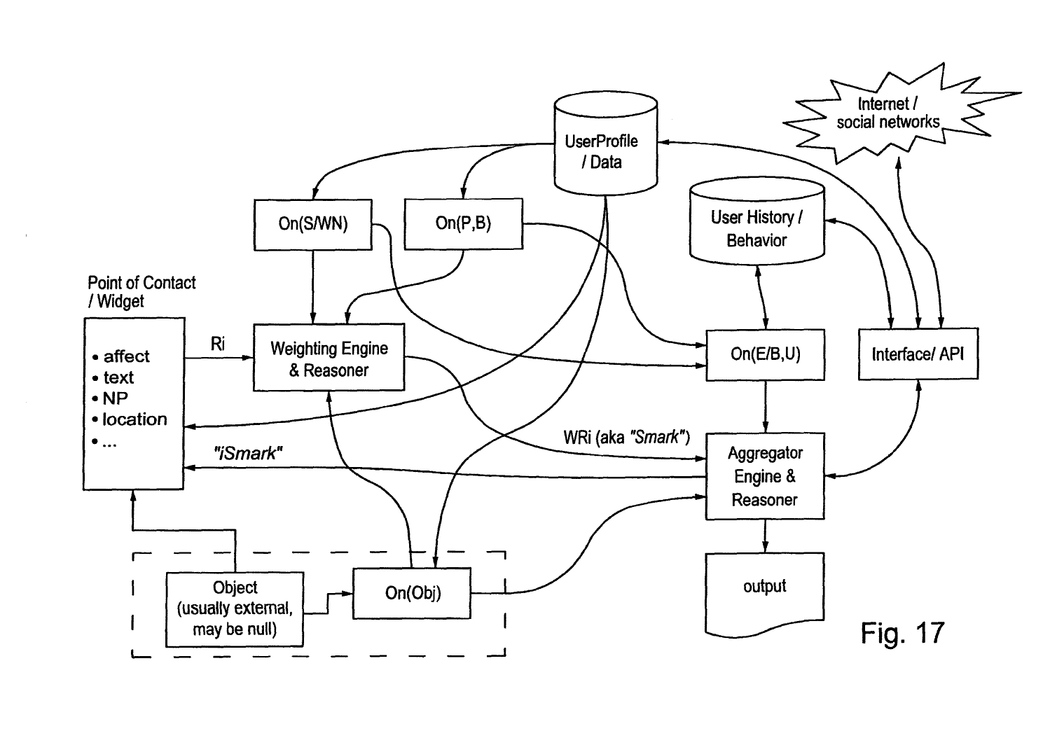

In the transformation above, f(x) can be a subjectivity (weighting) function that comprises a chain/set of modules that depend on individual characteristics (Ii), personality traits (Pi), demographics data (Di), and an ontology (On(Obj)) dependent on an object (Obj). The personality traits and demographics data can be received from the user and stored into memory once the user registers the user's profile with the membership server. With regard to the ontology (On(Obj)), the ontology can be null (i.e., nothing is known about the Object, or there is no Object—e.g. the user is just ‘posting’ some free thoughts) or be a subjective mapping. There may be no individual characteristics (Ii) at the beginning, but these individual characteristics can be learned from user behavior and/or from other (“bootstrapping”) methods. Personality traits can be determined from a personality test upon registration by the user. Demographics data can include age, gender, or other characteristics, as determined upon registration by the user. The manner of using the above factors to generate WRi can depend on general patterns uncovered by research. The semantic-affective space, and much more the users subjectivity, represent knowledge highly affected by imprecision and vagueness, therefore one way to implement such f( . . . ) (and Rf( . . . ) below) is by a set of fuzzy ontologies that inform a fuzzy reasoner/weighting-engine, as shown by the block diagram in FIG. 17.

In one embodiment, a set of rules can augment/implement part of the knowledge derived from patterns above. In one embodiment, the set of rules are software-implemented and are stored within accessible non-transitory memory. For example, rules can be statements like: (1) “Rating Ri tends to reflect more ‘disgust’ if the user has a high degree of personality trait A,” and (2) “adjust the values reflecting ‘disgust’ from this subject according to an appropriate sensitivity factor.” Therefore, one embodiment can compensate for the fact that a user has a high degree of personality trait A (which tends to cause the user to input “disgust”).

A current user Uo that is unregistered with a membership server can see a rating of Obj that is computed based on an average of all ratings WRi from Ux. Specifically, although a registered current user can see a rating that is adjusted by the subjective characteristics of the current user, an anonymous (unregistered) current user would generally see the same ranking/rating as another anonymous user.

However, with a registered current user, the registered current user (a user, who is profiled and logged-into the membership server, can see an average of WRi values that are each transformed/remapped in accordance with characteristics of the current user's own stored profile.

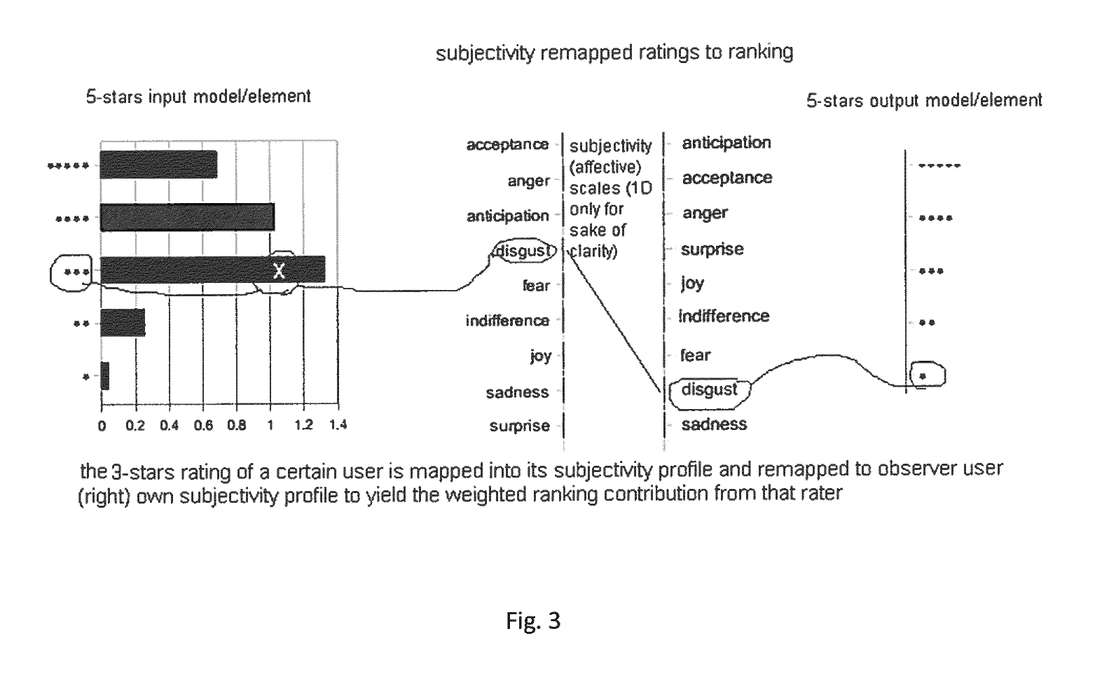

FIG. 3 illustrates transforming a rating to a weighted rating to an adjusted rating in accordance with one embodiment. For example, the following transformation can be implemented:

Ri=>f(Ii,Pi,Di,On(Obj))=>WRi=>Rf(o,Po,Do,On(Obj))=>WRo

In the transformation above, Rf(x) can be a reverse-weighting function of f(x) above, and Io, Po, Do can constitute a profile data set for current user Uo. In other words, the system tries to offer Uo with a rating of Obj as though the Ri had been given by users similar to Uo.

As such, a current registered user Uo is provided with a rating that has been adjusted in accordance with the current registered user Uo's own profile. Hence, a registered current user will likely get a rating of an object that is different than the rating received by another profiled or anonymous user.

For example, suppose a current user Uo is profiled. Further, suppose that the profile of the current user Uo indicates that current user Uo has lower levels of personality trait A, as compared to the average user. Further, suppose that the profile of current user Uo indicates that current user Uo has higher levels of personality trait O, as compared to the average user. One embodiment would then adjust the ratings of other users in accordance to a sensitivity factor that is dependent upon the levels of trait A and O in the current user.

In one embodiment, for non-affective ratings, On(x) can correspond to a subjective mapping. The subjective mapping can be obtained by a Q-Methodology (or some other established theory/method to deal with subjectivity).

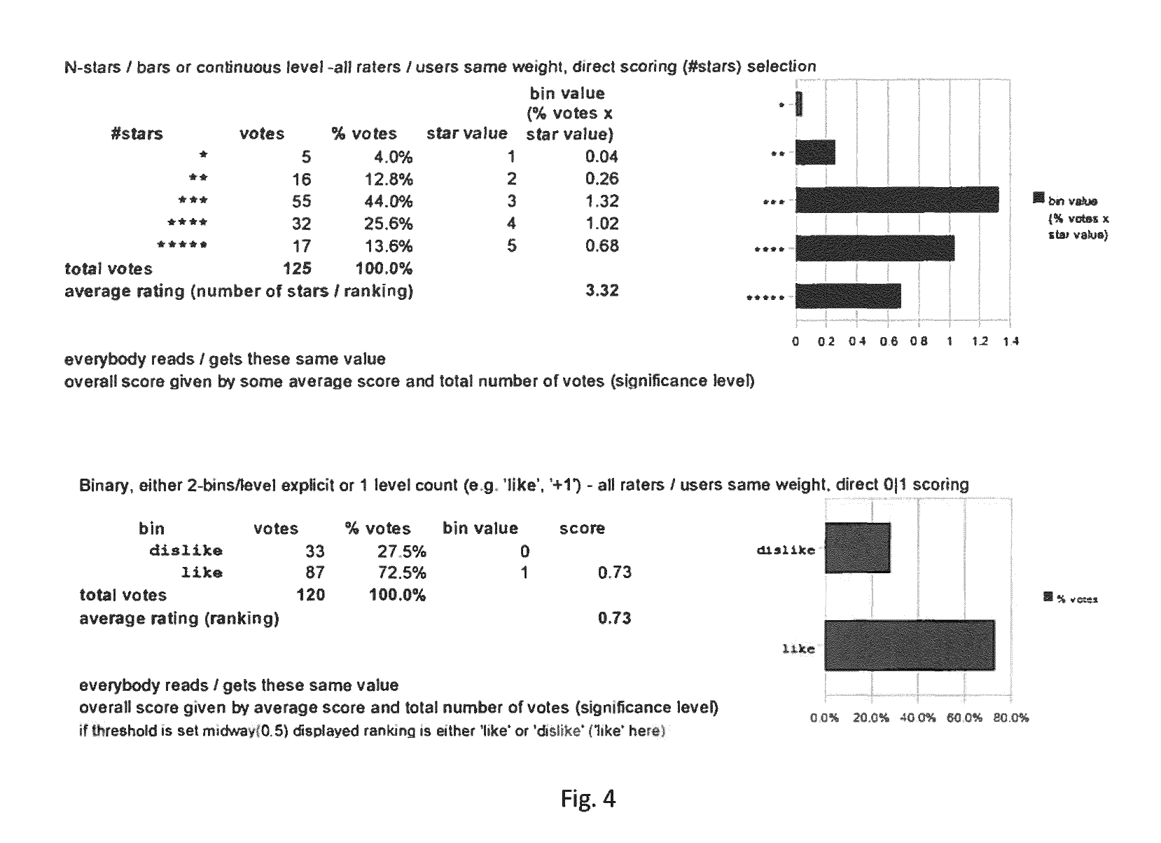

FIG. 4 illustrates example rating systems in accordance with one embodiment. FIG. 4 illustrates data used by a simple rating system for the five-star system shown in FIGS. 1 and 3. In FIG. 4, the data indicates that 4% of the users rated the object “one-star.” 12.8% of the users rated the object “two-stars.” 44.0% of the users rated the object “three-stars.” 25.6% of the users rated the object “four-stars.” 13.6% of the users rated the object “five-stars.” FIG. 4 also illustrates data used by a simple rating system for an example binary system shown in FIG. 1. The data of FIG. 4 indicates that 27.5% of users rated the object as “dislike,” and 72.5% of the users rated the object as “like.” Although FIG. 4 shows two different example rating systems to be used in conjunction with the present embodiments, other rating systems can be used as well.

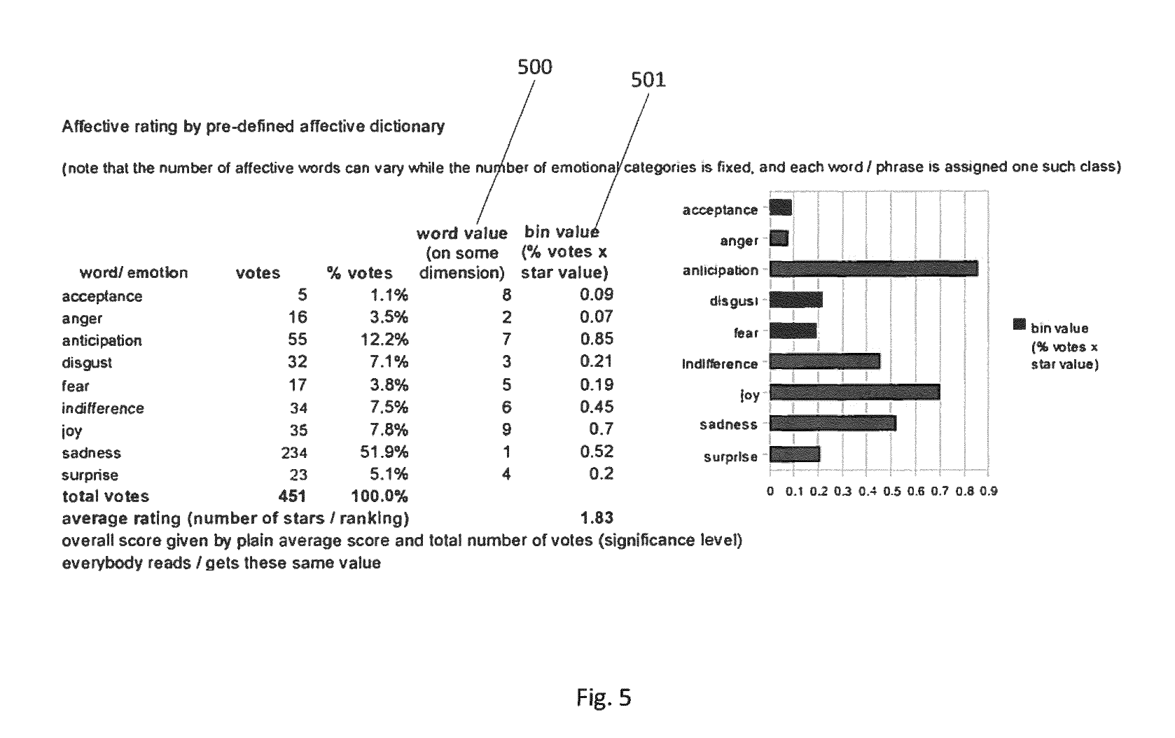

FIG. 5 illustrates an affective rating system in accordance with another embodiment. As discussed above, an object can be rated (‘tagged’) in accordance with different lexicon/words. Examples of lexicon/words can include the primary emotions in PKM: “acceptance,” “anger,” “anticipation,” “disgust,” “fear,” “indifference,” “joy,” “sadness,” and “surprise,” for example. As shown in column 500, different values can be associated with each lexicon/word according to some average (e.g. {P,A,D} values associated to each emotional state/word in PAD theory are averages over scores of many subjects; values in column 500 of FIG. 5 can be derived as some function of such {P,A,D}). The data can also include different “bin value” data in column 501. Bin-value data can correspond to (% votes multiplied by word value).

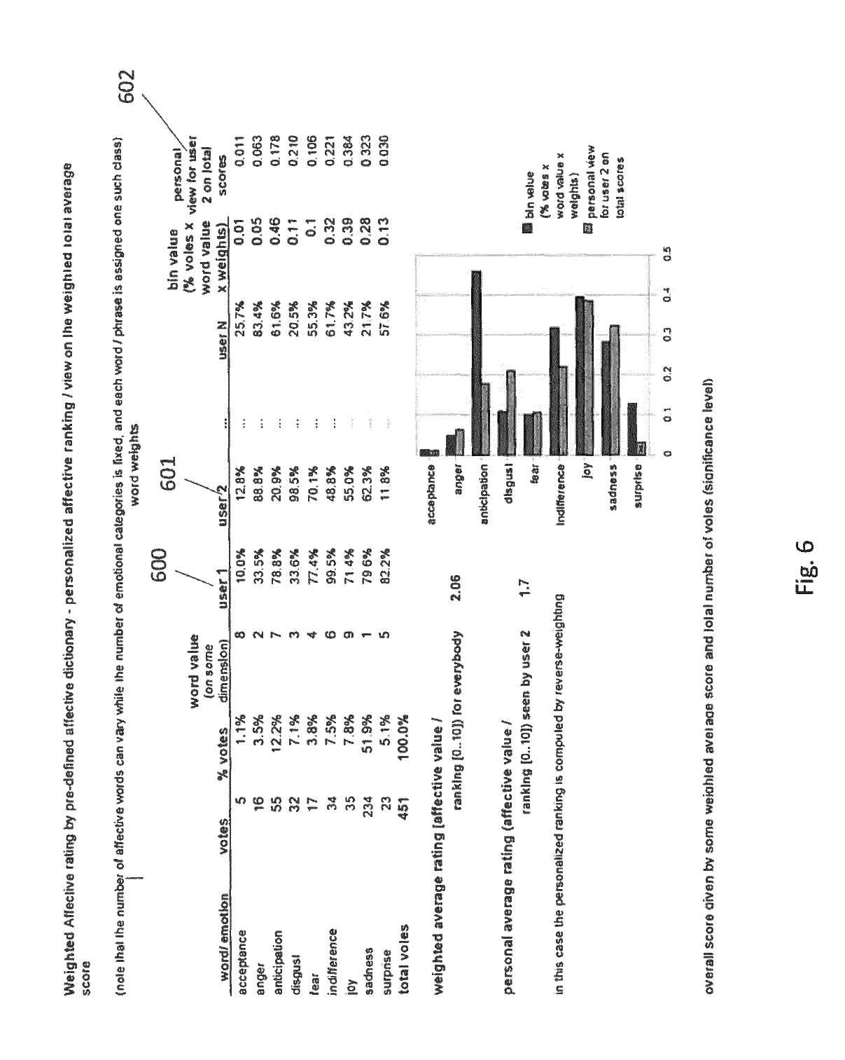

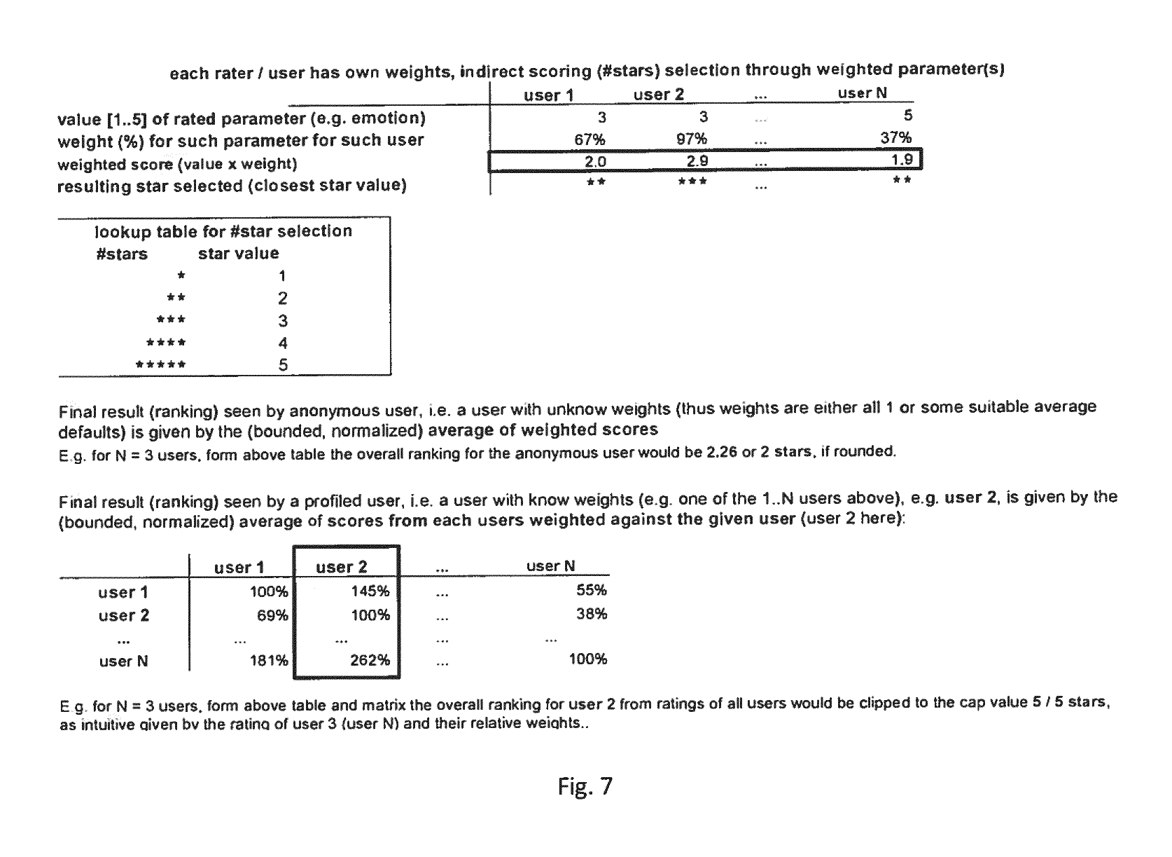

FIG. 6 illustrates comparing a simple rating system with a personalized rating system in accordance with one embodiment. Different users can have values associated with each of the different lexicons/words/emotions. For example, “user 1” has values shown in column 600 that are different than the values (of user 2) shown in column 601. FIG. 6 also includes data relating to a personal view for user 2 on total scores, as shown in column 602. Subjective weights in columns 600 and 601 can be outcomes from a Q-Methodology preferences test—see also FIGS. 2 and 3, for examples of bias/offset by different personalities. In this illustrative example, ranking for user 2 in column 602 are computed from a simple cross-weighting matrix like the one shown in FIG. 7 (column ‘user 2’ highlighted).

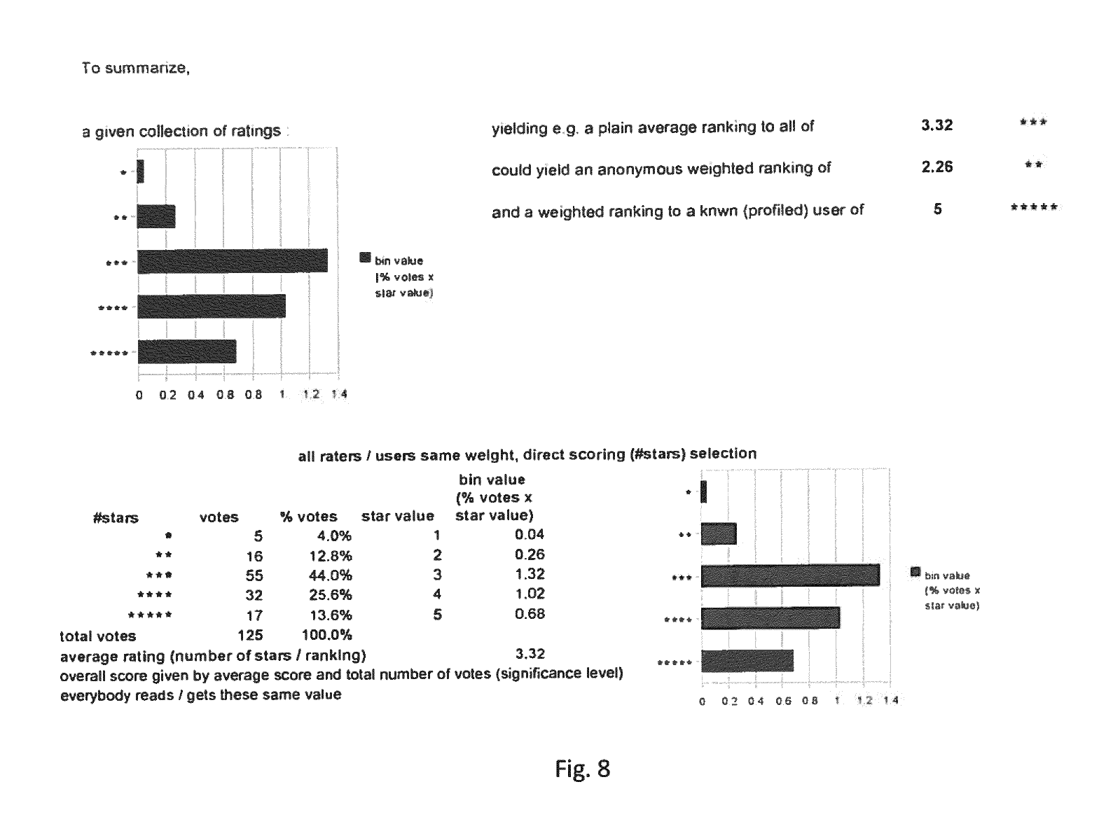

FIGS. 7 and 8 illustrate comparing a simple rating system with a personalized rating system in accordance with one embodiment. FIG. 7 shows transforming a weighted score to a resulting score that is specific to each of user 1, user 2, and user N. Here it's shown what could be the internal workings for such an example, basically the weighting engine: top table represents an internal raw score and an equivalent number of stars of each user's rating—the f( . . . ) mapping, bottom table shows the cross-weighting matrix to compute the reverse mapping Rf( . . . ). The overall outcomes for the 3 example users is shown in FIG. 8.

FIG. 8 illustrates comparing a simple rating system with a personalized rating system in accordance with one embodiment in FIG. 7. FIG. 8 illustrates a summary of calculated ratings. A personalized ranking can yield values quite different than simple average rating/ranking for different types of users: a simple non-weighted ranking would be 3 stars for all, whereas a weighted personalized ranking would be 2 stars for all anonymous users and 5 stars for the specific profiled user 2.

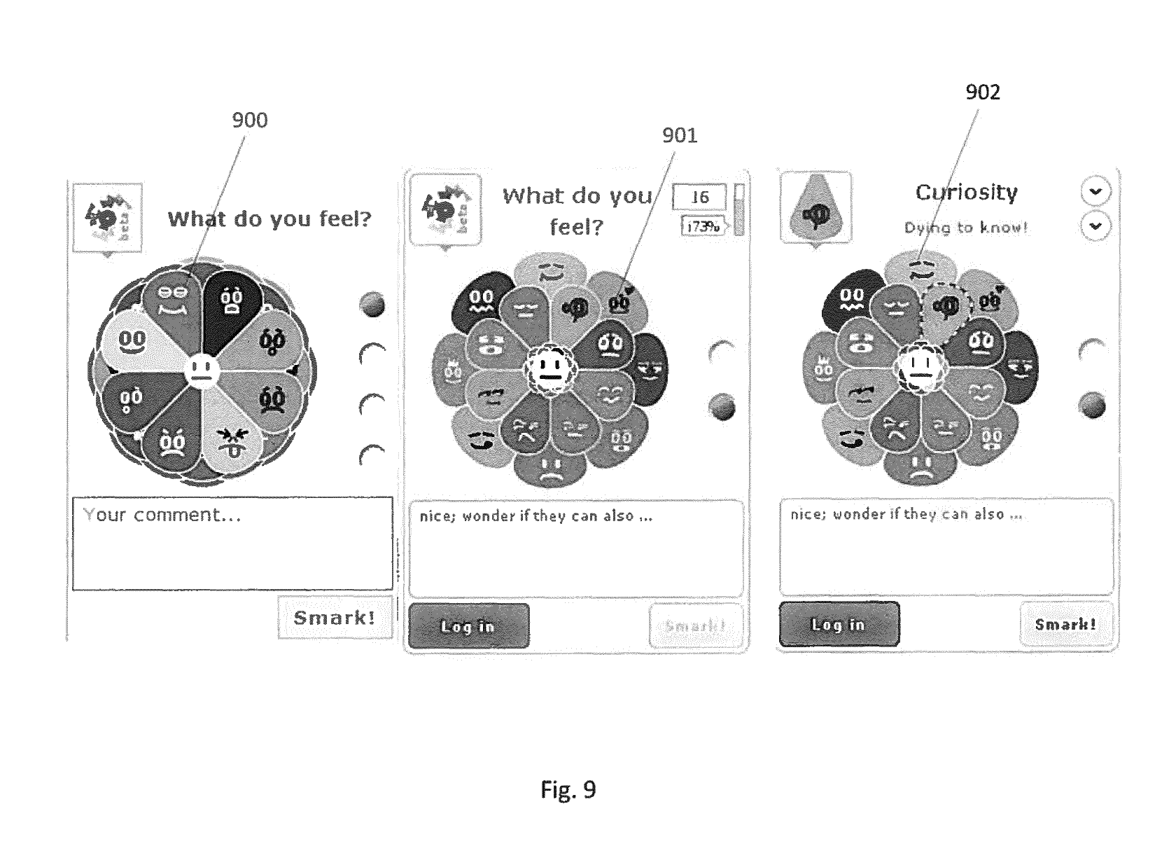

FIG. 9 illustrates graphical user interfaces of an input device in accordance with one embodiment. One embodiment is directed to a graphical-user interface (GUI) tool that enables users to provide an emotional tag (an e-tag) on objects. The GUI tool provides emotional models for explicit e-tagging of objects. E-tagging of objects can be performed using a set of labels (such as emotional lexical/terms from an Affect Dictionary), a face expression mapped to an Affect Dictionay and biased by personality (reflecting (PAD) mapped onto 2D input), 2D input space (such as MoodPad according to Thayer's E-T model or Russel's V-A circumplex), and/or a ColorPad. The end result of e-tagging should be an accurate affective expression of user satisfaction.

One embodiment provides a combined use of PAD, PKM, Five-Factor-Model (FFM) of personality along with a number of correlations documented in several research documents, among personality traits and general emotional appraisal patterns, to build a simple, rough affective behavioral model (aka ‘e-profile’ or ‘e-scale’) specific for each user. For example, an e-profile can have characteristics defined by a particular model, and the e-profile can be stored in memory in accordance to the configurations determined by the particular model. For example, the models can define the data structures that are used to store the e-profiles.

Certain correlations can exist between personality traits (hence, personality types) and sensitivity to such emotions. Also, the PAD model table can show huge variability of at least one of the dimensions. Therefore, it seems possible to derive an e-scale typical, to some extent, for each personality-type. Each registered user can then finely-adjust the e-scale as the user sees fit.

In one embodiment, the affective input device can display a graphical user interface. As previously described the input device can be a smart phone, a computer, or any other electronic device. One element of the graphical user interface may be a graphical representation of a wheel of emotions. The wheel of emotions can be a representation of Plutchik's wheel/theory of emotions. Referring to FIG. 9, the wheel of emotions can resemble a folded flower. The petals of the folded flower (such as 901-902) can be selected. Upon selection of each petal, the graphical user interface can transmit corresponding data for the selections that are graphically represented by each petal. As such, the user can indicate its affective state by selecting an appropriate petal to transmit the appropriate rating to the server/receiving terminal. Petals can correspond to some or all of the PKM classes of emotions, such as the primary emotions in the inner ring, and follow the arrangements—hence the relations—of the original Plutchik's wheel for the other secondary emotions in the outer rings. Embodiments that use such a wheel of emotions as an affective input device can help a user to decide on a complex emotion to pick/express, rather than just lazily picking/expressing a commonplace and general emotion, provided that such user grasps the basics of the relations underlying the layout of the wheel of emotions.

The emotions displayed in the wheel of emotions can be broad classes of emotions. Once a class of emotions is selected, a desired term from the member words of such a class can be selected from the drop-down menu on top of the interface. The user can customize the default word for each class and such choice has some impact on his e-profile, according to the semantic-affective dissimilarities with the ‘average’ default term.

In one embodiment, an index/bar located in the top-right corner can display an instantaneous on-topic, in-context, weighted and personal ranking to a current user (if the user is registered). The weighted and personal ranking may be a rating of an Object, and the ranking can be computed from a set of ratings provided by past users and/or determined based upon the current user's profile and context information. One embodiment can be bound to an instance of a widget. For example, the embodiment can be bound to a specific host web page or a photo.

The wheel of emotions can also include different colors and emoticons (“emotional icons”) to help a user to differentiate between the different displayed emotions. The user can customize the colors and emoticons as needed.

In one embodiment, once a user enters a rating via the user interface, the overall vector of values representing the user feedback output from the widget can be a vector Ri, as follows: Ri={emotion/term, text, X}

“X” can be null or correspond to a vector of values as additional properties of the affective rating (e.g., an index of canned text), and associated values from the context (e.g., for a time-varying property of the object being rated). One example of a time-varying property is a frame number of a video.

“Emotion/term” can be a term in the system lexicon. Intensity variants reflected by adverbs such as “very” and “a little” can be part of “X” or have an own index in the lexicon, depending on implementation details of the lexicon and the widget. Such “emotion/term” actually is usually a pointer into the lexicon. “Text” is the content of the free comment (hyper)text area in the widget.

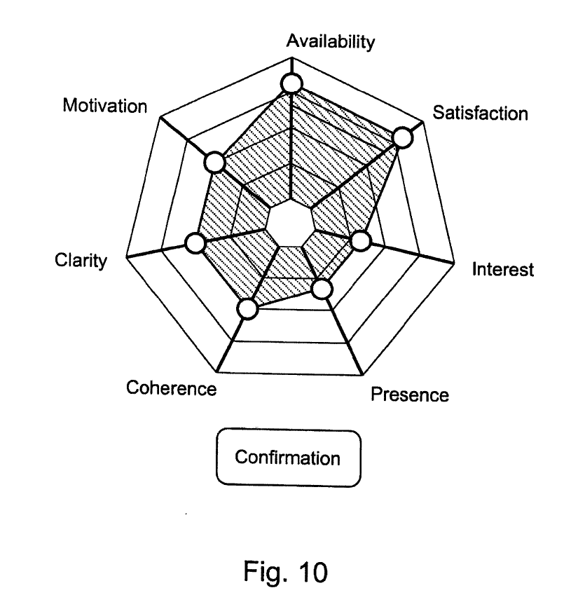

FIG. 10 illustrates a graphical user interface of an input device in accordance with another embodiment. This embodiment can include an N-Parameter companion widget. For cases of dealing with N non-affective parameters with (quasi) homogeneous scales, one embodiment uses a web/radar diagram, in a dual display/input mode. In one embodiment, if a user uses a pointing device (such as a mouse or a finger tip) to click on a portion of the displayed user interface, outside the axes, the user can lock and bind the parameter dots to move together according to such a click event. The parameter dots can move proportionally to their distance from the click point. If the click is outside the area defined by the points, the graph can expand or else contract. This embodiment allows a user to minimize a number of clicks/interactions while performing a rating task on N parameters, with N between 2 . . . 9, 9 being the practical limit of the usability of the GUI and typical overall max number of independent dimensions a user can reasonably rate at once.

One embodiment can allow a user to submit both an affective rating as well as a rating via the N-parameter companion widget. As such, in this embodiment, an overall rating from the user would be a vector Ri=(emotion/term, text, X, C, M, S, . . . , P) with the N parameters in suitable units (e.g. % or from finite set [1,2,3,4], etc.). “C,” “M,” and “S,” can correspond to “Chiarezza” (Clarity), “Motivazione” (Motivation), and “Soddisfazione” (Satisfaction), respectively, regarding a lesson, for example.

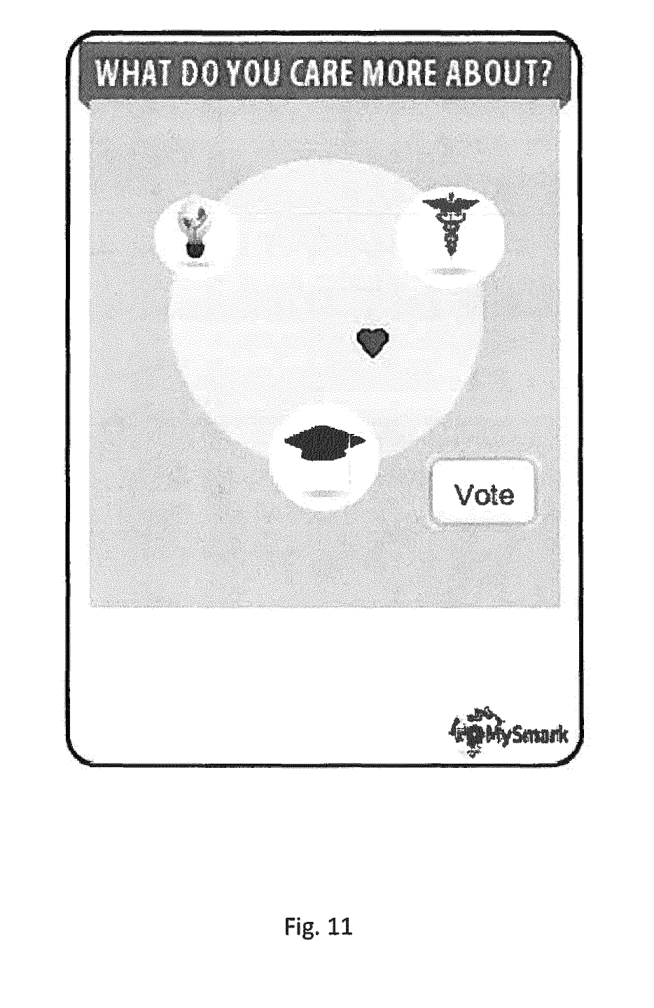

FIG. 11 illustrates a graphical user interface of an input device in accordance with one embodiment. In this embodiment, an N-Parameter companion widget can display a plurality of items and request the user to assign relative importance among the items. Referring to the example of FIG. 11, a user can move a pointer (heart) in the area between the items to visually assign a proportional amount of interest to each of the items. In this example, the companion widget can be used to collect information for political polling purposes. The polling may want to determine which issues are most important to a user. For example, the items/issues may include healthcare (represented by the medical symbol in the upper right portion), education (represented by the graduation cap), and energy/environment (represented by the lightbulb).

This N-parameter companion widget can be presented alone or in conjunction with other rating interfaces. Therefore, the user can use this N-parameter companion widget before or after the affective input. One embodiment can combine the affective widget in a complete panel to provide a single step feedback. After using the N-parameter companion widget, the user can input a rating in the form of a vector Ri from the user. Vector Ri would be a vector: Ri=(emotion/term, text, X, E %, H %, N %). “E,” “H,” and “N” can represent education, health, and energy/environment, respectively.

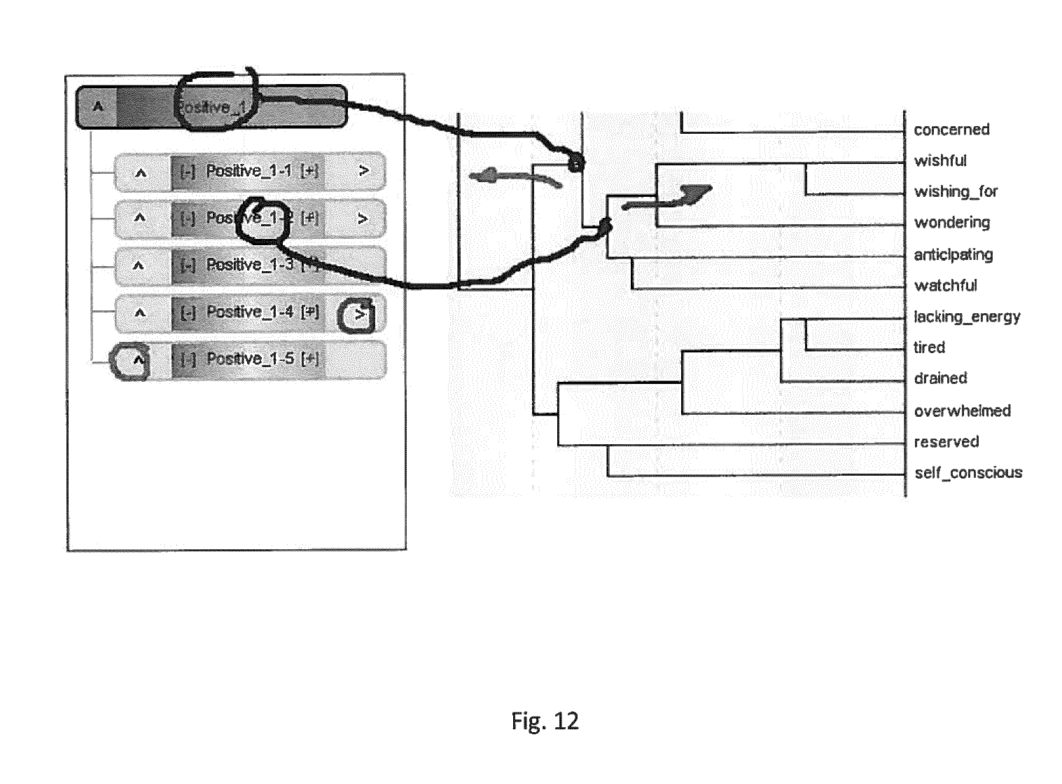

FIG. 12 illustrates a graphical user interface of an input device in accordance with another embodiment. This embodiment uses an alternative affective input widget. In this embodiment, a widget is even more tied to the affective lexicon structure. Lexical terms related to a realm have similarity and relatedness which form hierarchical clusters and are usually represented in dendograms. Thus, one embodiment uses a dendogram-browser which looks and works basically like a directory tree browser. Using this dendogram browser, a user can cast its affective vote at a level of detail that it wants. The user can cast its affective vote starting from a binary positive/negative (thumb up/down) down to the word leafs. The intermediate nodes are named conveniently (sub-classes, similar to the petals in the rose, which can be thought of as a cut through the dendogram at a certain level).

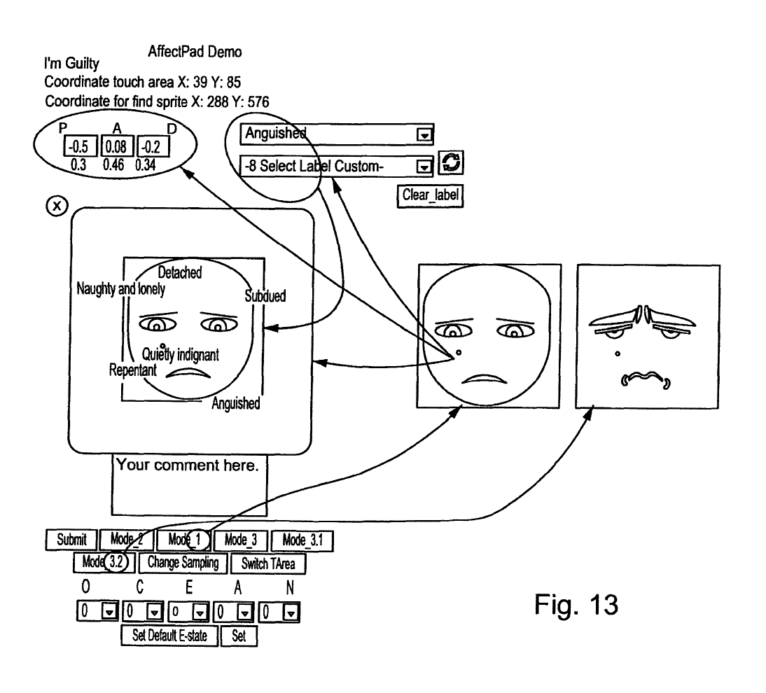

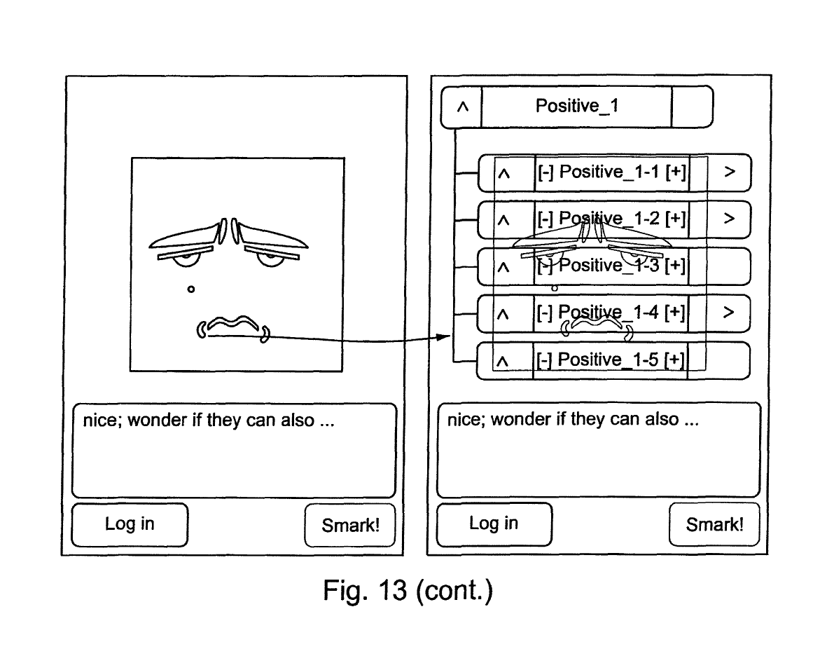

FIG. 13 illustrates graphical user interfaces of an input device in accordance with one embodiment. Affective input devices can focus on graphics, such as facial expressions.

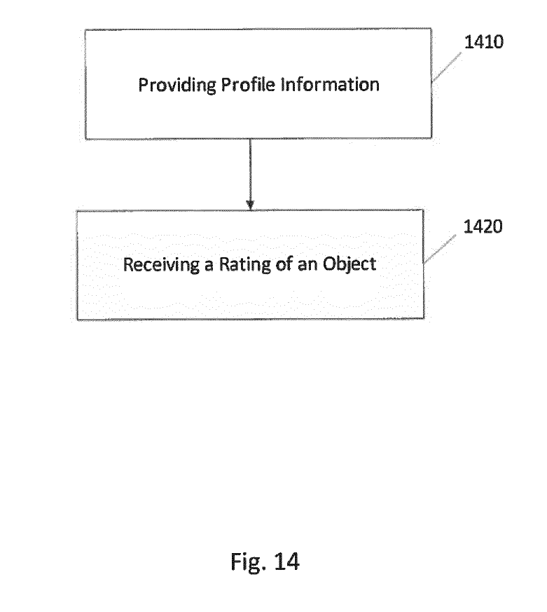

FIG. 14 illustrates a flowchart of a method in accordance with one embodiment. The method of FIG. 14 can be performed by at least one processor. The at least one processor can perform the method upon processing instructions stored on non-transitory computer-readable memory. The method illustrated in FIG. 14 includes, at 1410, providing profile information of a current user. At 1420, one embodiment receives a rating of an object. The received rating of the object is based on a plurality of other ratings of the object inputted by a plurality of other users. The plurality of other ratings are transformed to a plurality of weighted ratings. The plurality of weighted ratings are transformed to determine the received rating of the object. The received rating of the object is determined according to the provided profile information of the current user.

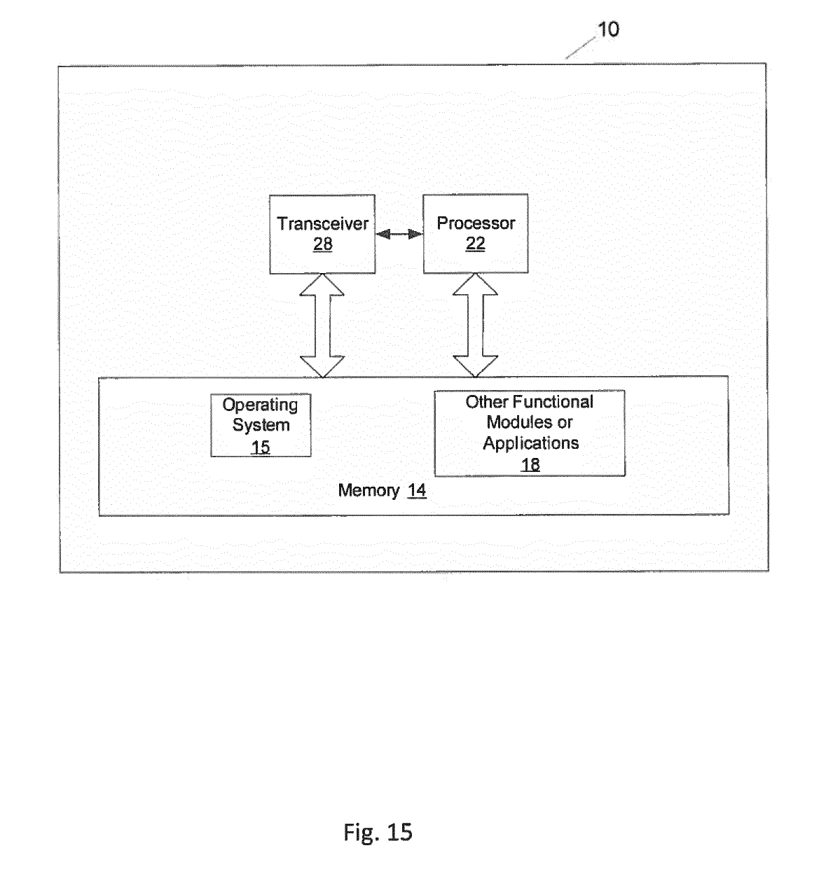

FIG. 15 illustrates an apparatus 10 according to another embodiment. In an embodiment, apparatus 10 can be a smartphone, computer, or other electronic device, for example.

Apparatus 10 can include a processor 22 for processing information and executing instructions or operations. Processor 22 can be any type of general or specific purpose processor. While a single processor 22 is shown in FIG. 15, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

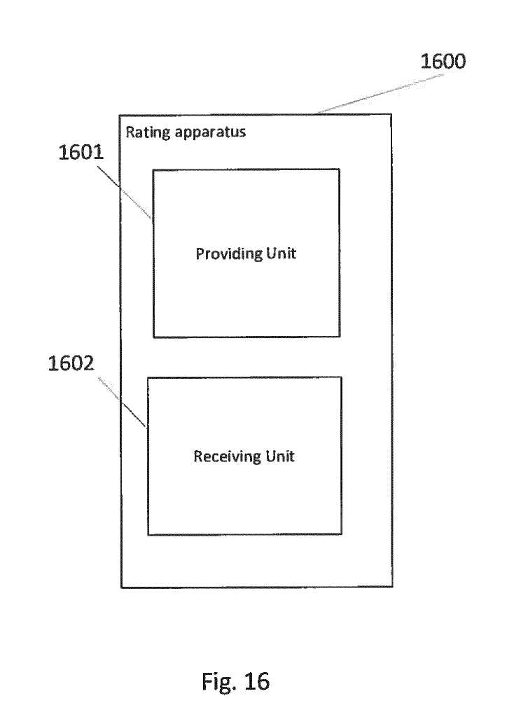

FIG. 16 illustrates an apparatus 1600 according to another embodiment. Apparatus 1600 can include a providing unit 1601 that provides profile information of a current user. Apparatus 1600 can also include a receiving unit 1602 that receives a rating of an object. The received rating of the object is based on a plurality of other ratings of the object inputted by a plurality of other users. The plurality of other ratings are transformed to a plurality of weighted ratings. The plurality of weighted ratings are transformed to determine the received rating of the object. The received rating of the object is determined according to the provided profile information of the current user.

FIG. 17 illustrates an apparatus in accordance with one embodiment. As illustrated in FIG. 17, a point of contact is where the interaction with the user is supposed to happen. The point of contact can be considered to be where the widget is displayed, such as a screen of some device. In one embodiment, data from the widget is collected and sent to a system in the form of an output vector Ri. In this embodiment, “I” can represent a single user ‘i’ among the populations of users who interacted with the system. As discussed above, “Ri” is fed into a weighting engine. The weighting engine can be controlled by different ontologies. The ontologies can comprise On(S/WN), On(P,B), and On(Obj), for example. On(S/WN) can be a semantics/psycholinguistic ontology, for example at present based on (augmented) WordNet and SentiWordNet. On(P,B) can be a psychological, behavioral ontology, based on the general patterns relating personality traits and emotions appraisal mentioned earlier. On(Obj) can be a variable (such as a plug-in) ontology which accounts for the properties of the Object being rated. For example, if the object being rated is a travel/tourism/eating experience, one embodiment uses a related user subjectivity pattern and/or a domain-specific knowledge model. A subjectivity pattern in this context can be again a preference profile assessed via e.g. Q-Method on dietary, for eating, or a sensibility profile regarding hotel/room features like cleanness, quiet, style etc. Domain-specific knowledge model can be e.g. an ontology on hosting requirements and habits for elderly or an ontology relating room/site characteristics to personality traits. Therefore, the link from the user profile, as another significant example, can consider rating of a music experience where an affective rating can be considered in a special way. A domain-specific knowledge model can be an ontology on music-elicited emotions.

User Profile/Data can be stored within a database. The profile can comprise extensions related to subjectiveness that are calibrated and stored for Objects. A user history/behavior is a database of all user activities. Interface/API is a block/glueware to exchange data with other systems (e.g., a sign-in, machine-to-machine, etc.). On(E/B,U) can be an ontology of Emotions/Behavior (tailored to the current user), for example, at present, the preferred implementation seems a Belief-Desire-Intention (BDI) agency framework integrating cognitive appraisal (based on the OCC model of emotions) and personality, modeling user behavior, linked to the semantic-affective model used on the input and weighting side. The result of the Weighting engine is a transformed vector WRi. Vector WRi can be referred to as a “smart mark” (Semantic/Sentiment/Smart-mark). This smart mark can embody an original information weighted by the relevant user's subjective characteristics. The user's subjective characteristics are fed to an Aggregator Engine & Reasoner. The Aggregator Engine & Reasoner (actually, part of the BDI framework above) can be responsible for computing the overall rankings from data, to be displayed in real time, on-context, to the users as a synthetic index that is easy to understand. Output vector can include predictive behavioral information related to the single user “i” and the rest of the population, in relation to the characteristics of the Object (present and past) that can be useful for further actions. For example, in a multi-step rating arrangement, if/how to present a further non-affective rating step like, for example, those illustrated in FIGS. 10 and 11.

In one embodiment, a smart mark can include an affective payload content that is in the explicit tag from the affective input device, regardless of any (hyper)text content. The smark can be thought of as a meme with an affective tag like a wrapper around a whole data set from the user action. The ontologies, together with the user data, form a user behavioral model. The output (ranking) vector can already carry an implicit predictive capability, to some extent.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
providing profile information of a current user;
receiving a rating of an object, wherein the received rating of the object is based on a plurality of other ratings of the object inputted by a plurality of other users, the plurality of other ratings are transformed to a plurality of weighted ratings, the plurality of weighted ratings are transformed to determine the received rating of the object, and the received rating of the object is determined according to the provided profile information of the current user.

2. The method according to claim 1, wherein the received rating of the object is a multi-dimensional rating, and each of the other ratings inputted by the plurality of other users is a multi-dimensional rating.

3. The method according to claim 1, wherein transforming the plurality of other ratings to the plurality of weighted ratings comprises applying a subjectivity weighting function that depends on individual characteristics of the other users, personality traits of the other users, demographic data of the other users, and a first ontology dependent on the object.

4. The method according to claim 1, wherein transforming the plurality of weighted ratings to determine the received rating of the object comprises applying a reverse-weighting function that depends on individual characteristics of the current user, personality traits of the current user, demographic data of the current user, and a second ontology dependent on the object.

5. The method according to claim 1, wherein the dimensions of the multi-dimensional rating are affective expressions defined by a theory and model of emotions.

6. The method according to claim 1, wherein transforming the plurality of other ratings to the plurality of weighted ratings comprises applying a subjectivity weighting function that depends on a first ontology dependent on the object, a second ontology that is a semantics/psycholinguistic ontology, and a third ontology that is a psychological behavioral ontology.

7. The method according to claim 1, further comprising processing the weighted ratings using an aggregator engine & reasoner, wherein processing the weighted ratings using the aggregator engine & reasoner depends on a fourth ontology that is an emotions/behavior ontology.

8. An apparatus, comprising:
at least one processor; and
at least one memory including computer program code,
the at least one memory and the computer program code configured, with the at least one processor, to cause the apparatus at least to
provide profile information of a current user;
receive a rating of an object, wherein the received rating of the object is based on a plurality of other ratings of the object inputted by a plurality of other users, the plurality of other ratings are transformed to a plurality of weighted ratings, the plurality of weighted ratings are transformed to determine the received rating of the object, and the received rating of the object is determined according to the provided profile information of the current user.

9. The apparatus according to claim 8, wherein the received rating of the object is a multi-dimensional rating, and each of the other ratings inputted by the plurality of other users is a multi-dimensional rating.

10. The apparatus according to claim 8, wherein transforming the plurality of other ratings to the plurality of weighted ratings comprises applying a subjectivity weighting function that depends on individual characteristics of the other users, personality traits of the other users, demographic data of the other users, and a first ontology dependent on the object.

11. The apparatus according to claim 8, wherein transforming the plurality of weighted ratings to determine the received rating of the object comprises applying a reverse-weighting function that depends on individual characteristics of the current user, personality traits of the current user, demographic data of the current user, and a second ontology dependent on the object.

12. The apparatus according to claim 8, wherein the dimensions of the multi-dimensional rating are affective expressions defined by a theory and model of emotions.

13. The apparatus according to claim 8, wherein transforming the plurality of other ratings to the plurality of weighted ratings comprises applying a subjectivity weighting function that depends on a first ontology dependent on the object, a second ontology that is a semantics/psycholinguistic ontology, and a third ontology that is a psychological behavioral ontology.

14. The apparatus according to claim 8, wherein the apparatus is further caused to process the weighted ratings using an aggregator engine & reasoner, wherein processing the weighted ratings using the aggregator engine & reasoner depends on a fourth ontology that is an emotions/behavior ontology.

15. A computer program product, embodied on a non-transitory computer readable medium, the computer program product configured to control a processor to perform a process, comprising:
providing profile information of a current user;
receiving a rating of an object, wherein the received rating of the object is based on a plurality of other ratings of the object inputted by a plurality of other users, the plurality of other ratings are transformed to a plurality of weighted ratings, the plurality of weighted ratings are transformed to determine the received rating of the object, and the received rating of the object is determined according to the provided profile information of the current user.

16. The computer program product according to claim 15, wherein the received rating of the object is a multi-dimensional rating, and each of the other ratings inputted by the plurality of other users is a multi-dimensional rating.

17. The computer program product according to claim 15, wherein transforming the plurality of other ratings to the plurality of weighted ratings comprises applying a subjectivity weighting function that depends on individual characteristics of the other users, personality traits of the other users, demographic data of the other users, and a first ontology dependent on the object.

18. The computer program product according to claim 15, wherein transforming the plurality of weighted ratings to determine the received rating of the object comprises applying a reverse-weighting function that depends on individual characteristics of the current user, personality traits of the current user, demographic data of the current user, and a second ontology dependent on the object.

19. The computer program product according to claim 15, wherein the dimensions of the multi-dimensional rating are affective expressions defined by a theory and model of emotions.

20. The computer program product according to claim 15, wherein transforming the plurality of other ratings to the plurality of weighted ratings comprises applying a subjectivity weighting function that depends on a first ontology dependent on the object, a second ontology that is a semantics/psycholinguistic ontology, and a third ontology that is a psychological behavioral ontology.

21. The computer program product according to claim 15, wherein the process further comprises processing the weighted ratings using an aggregator engine & reasoner, wherein processing the weighted ratings using the aggregator engine & reasoner depends on a fourth ontology that is an emotions/behavior ontology.
